(19) United States
(12) Patent Application Publication
(10) Pub. No.: US 2010/0014654 A1
(43) Pub. Date: Jan. 21, 2010

(54) Retablissement d'appel dans un serveur d'appel d'installation de telecommunications privee

(75) Inventor: Jean-Pierre Mercuriali, Orsay (FR)

Correspondence Address: LOWE HAUPTMAN HAM & BERNER, LLP, 1700 DIAGONAL ROAD, SUITE 300, ALEXANDRIA, VA, 22314, US

(73) Assignee: AASTRA MATRA TELECOM, GUYANCOURT (FR)

(21) Appl. No.: 12/373,663

(22) PCT Filed: Jul. 10, 2007
(86) PCT No.: PCT/FR2007/051624

§ 371 Date: Jul. 16, 2009

(30) Foreign Application Priority Data
Jul. 13, 2006 (FR) 0606411

(51) Int. Cl. H04M 7/00

(52) U.S. Cl. 379/221.05

(57) ABSTRACT

For quickly restoring a previously set up call between first and second terminals associated respectively with first and second call servers, a first call string associated with the first terminal and with a first context of the call previously stored in the first server is created. A call restoring request including a second call string reference extracted from the first context is transmitted from the first to the second server. In the second server, a second call string is searched depending on the reference included in the request. If the second string is found in association with the second terminal, call restoring between the first and the second terminals through a path between the first and the second call strings is confirmed from the second server to the first server.

The present invention relates to a call server for managing calls in a business private telecommunications facility. More particularly, it concerns, in the call server, the way to restore a call previously set up in relation with a terminal connected with the call server.

In the private telecommunications facility, the call server is connected through a local area network with gateways serving local user terminals and an access to telecommunications networks. It assigns addresses to terminals and gateways and manages numerous calls between local terminals and remote terminals. Gateways exchange signaling with the call server during calls. A call string is created in the call server for each call in which a local area terminal takes part.

If an incident occurs in the operation of the call server, resulting in a loss of call strings stored in the memory of the call server, either the normal operation of the call server is very rapidly restored, or, in the case of an extended breakdown, it is replaced by an emergency call server connected with the local area network and having stored the same static data relative to the characteristics of the terminals and to the facility architecture. In all cases, the call strings are deleted, resulting in breaking the pathways for the previously set up calls before the incident and releasing the calling terminals and the called ones in the facility.

Moreover, registering data relative to the management of a call string during a call on the hard drive of the call server is time-consuming and can delay some phases upon the occurrence of a call. Similarly, transferring data from the hard disk to another hard disk between call and emergency servers is time-consuming and can delay restoring the establishment of the call signaling by the emergency call server.

An object of the invention is to overcome the above-mentioned disadvantages and, more particularly, to quickly restore previously set up calls in the facility when a call server suddenly becomes defective.

Accordingly, a method of restoring a previously set up call between a first terminal associated with a first call server and a second terminal associated with a second call server, is characterized in that it comprises the steps of:

creating a first call string associated with the first terminal and with a first context of the call previously stored in the first call server,

transmitting a call restoring request including a second call string reference extracted from the first context from the first call server to the second call server,

searching in the second call server a second call string depending on the second call string reference included in the call restoring request, and,

if the second call string is found in association with the second terminal, confirming call restoring between the first and the second terminals through a path between the first and the second call strings, from the second call server to the first call server.

The first and the second terminals can be respectively a calling terminal and a terminal called by the calling terminal or, inversely, the called terminal and the calling terminal.

Dynamic signaling data of each on going call in a context of a call being stored on the hard disk of the first call server are reduced to the strict need for restoring the call signaling by the first server. Restoring the call is thus very quick. The dynamic signaling data included in the call restoring request can be the address of the first terminal, the address of the second terminal and the reference of the second call string extracted from the first context, and the reference of the first call string created in the first call server. For example, toggling the defective main call server to an emergency call server and restoring the call by the emergency call server are thus very quick.

Generally speaking, if a main call server in a private telecommunications facility including the first terminal should become defective, and if the failure of said main call server is very rapidly inhibited, restoring the call occurs in the main call server as a first call server. However, if repairing the failure of the main call server is to be time-consuming, the first call server can be an emergency server of the private telecommunications facility adapted to replace the main call server that has become defective and with which the first terminal is also associated.

According to another embodiment, the first call server and the second call server are merged into one single call server that can be a main call server or an emergency call server of a private telecommunications facility common to the first and the second terminals.

The invention also provides a system for restoring a call previously set up between one first terminal associated with a first call server and a second terminal associated with a second call server. The system is characterized in that it comprises:

means in the first call server for creating a first call string associated with the first terminal and with a first context of the call previously stored in the first call server,

means in the first call server for transmitting a call restoring request including a second call string reference extracted from the first context to the second call server,

means in the second call server for searching a second call string depending on the second call string reference included in the call restoring request, and

if the second call string is found in association with the second terminal, means in the second call server for confirming call restoring between the first and the second terminals through a path between the first and the second call strings, from the second call server to the first call server.

The invention further relates to call servers.

According to a first embodiment, a call server adapted to restore a call previously set up between a first terminal associated with it and a second terminal associated with a second call server, can comprise according to the invention:

means for creating a first call string associated with the first terminal and with a first context of the first call previously stored in the call server, and

means for transmitting a call restoring request including a second call string reference extracted from the first context to the second call server,

so that the second server searches a second call string depending on the second call string reference included in the call restoring request, and, if the second call string is found in association with the second terminal, confirms call restoring between the first and the second terminals through a path between the first and the second call strings, to said first call server.

The invention also relates to a computer program adapted to be implemented in the call server according to the first embodiment. The program is characterized in that it comprises instructions which, when the program is loaded and run in said call server according to the first embodiment, perform the following steps of:

creating a first call string associated with the first terminal and with a first context of the first call previously stored in the call server, and

transmitting a call restoring request including a second call string reference extracted from the first context to the second call server,

so that the second server searches a second call string depending on the second call string reference included in the call restoring request, and, if the second call string is found in association with the second terminal, confirms call restoring between the first and the second terminals through a path between the first and the second call strings, to said first call server.

According to a second embodiment, able to be combined with the first embodiment, a call server for restoring a call previously set up between a first terminal associated with a first call server and a second terminal associated with it, can comprise according to the invention:

means for searching a second call string depending on a second call string reference included in a call restoring request transmitted by the first call server and extracted from a first context of the call previously stored in the first call server having created a first call string associated with the first terminal, and

if the second call string is found in association with the second terminal, means for confirming a call restoring between the first and the second terminals through a path between the first and the second call strings, to the first call server.

The invention also relates to a computer program adapted to be implemented in the call server according to the second embodiment. The program is characterized in that it comprises instructions which, when the program is loaded and run in said call server according to the second embodiment, perform the following steps of:

searching a second call string depending on a second call string reference included in a call restoring request transmitted by the first call server and extracted from a first context of the call previously stored in the first call server having created a first call string associated to the first terminal, and

if the second call string is found in association with the second terminal, confirming a call restoring between the first and the second terminals through a path between the first and the second call strings, to the first call server.

Other features and advantages of the present invention will become more clearly apparent when reading the following description of several embodiments of the invention given by way of nonlimiting examples, with reference to the corresponding appended drawings in which:

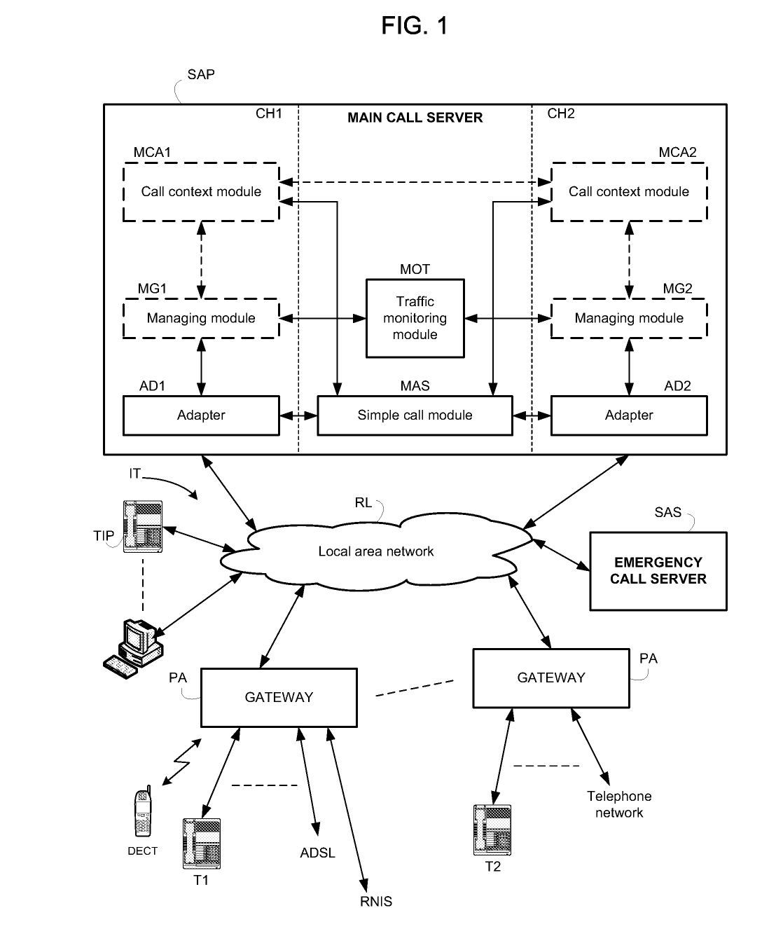

FIG. 1 is a schematic block diagram of a private telecommunications facility comprising a main call server and an emergency call server according to this invention;

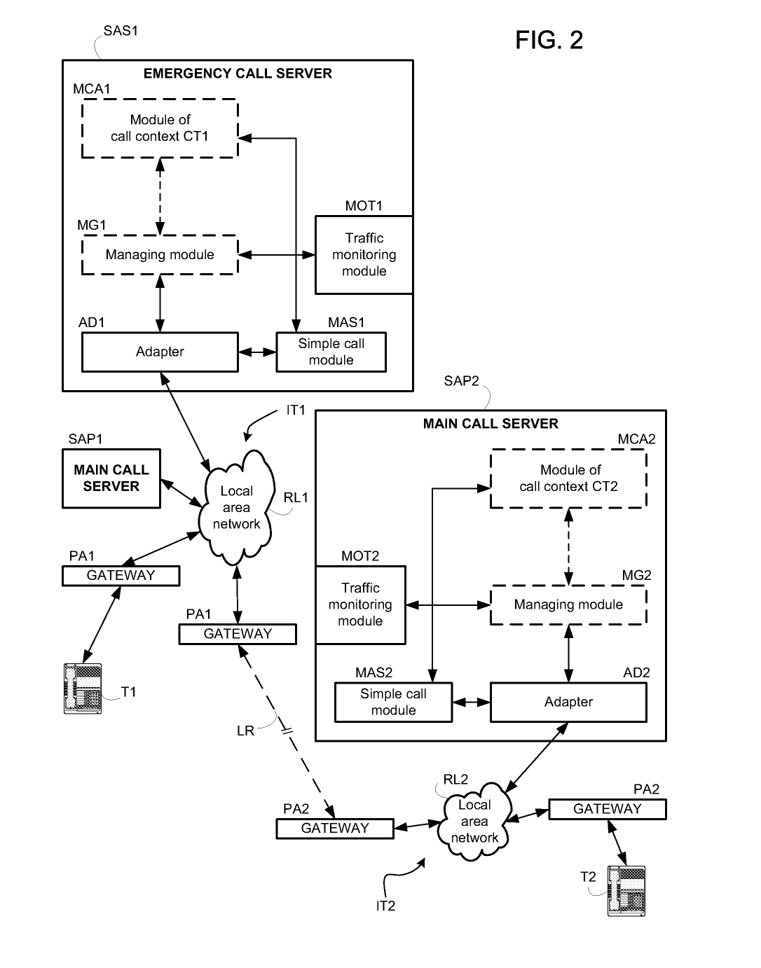

FIG. 2 is a block diagram of two private telecommunications facilities with terminals communicating between them; and

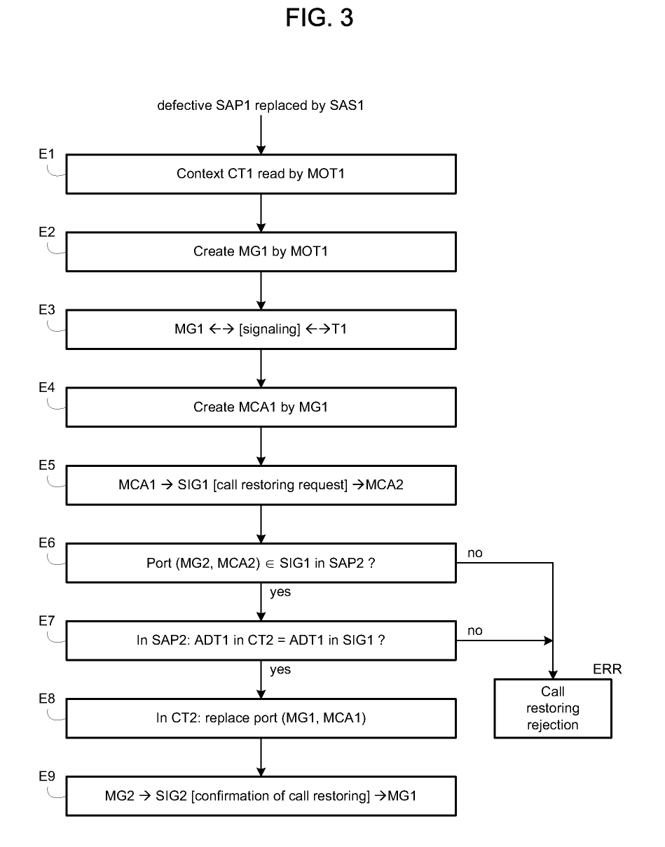

FIG. 3 is a flow chart of a call restoring method according to the invention, in relation to the private telecommunications facilities of the figure, one of them including a main call server that has become defective.

Referring to FIG. 1, a private telecommunications facility IT comprises a main call server SAP, an emergency call server SAS, a business local area network RL and gateways PA.

The main call server SAP particularly comprises a simple call module MAS, a traffic monitoring module MOT according to the invention and a first part comprising an network adapter AD1 and dedicated to outgoing call strings CH1 and a second part comprising a network adapter AD2 and dedicated to incoming call strings CH2. In order to prevent overloading of the FIG. 1, only one outgoing call string CH1 and one incoming call string CH2 are shown.

The simple call module MAS creates an outgoing call string CH1 when an outgoing call is set up from a calling terminal T1 associated with the server SAP and creates an incoming call string CH2 when an incoming call is set up with a called terminal T2 associated with the server SAP. Each string CH1, CH2 comprises a managing software module MG1, MG2 linked to the network adapter AD1, AD2 and a software module of call context MCA1, MCA2 linked to the managing module.

The call server SAP is implemented for example in a computer or a dedicated platform. It can play the role of a gatekeeper meeting the signaling protocol H.323 or SIP (Session Initiation Protocol). It communicates in the facility by means of signaling messages. But the call server SAP does not deal with audio and/or video data packets exchanged between two terminals optionally by means of their respective gateways during a call set up between them. The data packet flow is managed, for example, according to the real time transport protocol of the data flow from end to end.

The emergency call server SAS is connected with the main call server SAP through the local area network RL and is not represented in detail in FIG. 1 as it includes material and software components similar to the above-mentioned ones of the main call server SAP.

The local area network RL operates in a packet mode according to the transfer protocol TCP/IP (“Transmission Control Protocol/Internet Protocol”) on which the data flow protocol RTP relies. The local area network RL is for example, partially of the wire type LAN (“Local Area Network”) and/or partially of the wireless type WLAN (“Wireless Local Area Network”). It connects the network adapters AD1 and AD2 of the servers SAP and SAS with several multimedia gateways PA, only two of which are shown on FIG. 1. The adapters retransmit signaling packets for treating calls in the managing modules and in addition, ensure other services such as a directory search and a vocal message handling for example.

Gateways PA comprise communication interfaces adapted for servicing heterogeneous user terminals belonging to the business possessing the local area network RL, by means of lines inside the private telecommunications facility. Such terminals are, for example, conventional analog or digital telephone terminals T1, T2, personal computers, fax machines, low range digital radio terminals of the DECT type (“Digital Enhanced Cordless Telecommunications) or according to an IEEE standard 802.1xx and meeting the certification label WiFi (Wireless Fidelity). Some gateways PA are connected, through lines outside the private telecommunications facility, particularly to “public” telecommunications networks such as the internet for voice communications according to the protocol IP (“Internet Protocol”) particularly through lines of the ADSL type (“Asynchronous Digital Subscriber Line”), and/or access to various flow rates of an integrated Services Digital Network ISDN.

Each gateway PA interconnects the local terminals with the local area network and ensures intermediary connections for directing outgoing calls of local calling terminals to local or remote called terminals via the local area network RL and incoming calls from local or remote calling terminals to local called terminals via the call server SAP and the local area network RL. The gateway manages and adapts physical resources between its ports particularly connected with the terminals and the external networks depending on a signaling exchanged with the call server that it adapts to the own signalings of the terminals and the network access it services. The gateway is similar to a private switch of the PABX type with no intelligence for service applications particularly relating to the signaling relative to call setting up and managing and dedicated to the call server.

Other terminals TIP compatible with the transfer protocol TCP/IP and providing functions, including telephone ones, similar to those of the above-mentioned terminals are directly connected with the local area network RL.

The main call server SAP comprises a static data base including addresses, it has assigned, preferably dynamically, to all the gateways PA, to the local user terminals and to the various above-mentioned network accesses of the private telecommunications facility IT, particularly via matches between telephone numbers of conventional terminals and addresses IP. The static data base also includes profiles of the users of local terminals and characteristics of local terminals as well as characteristics on the architecture of the private facility IT. Such static data are simultaneously recorded in a data base of the emergency call server SAS.

All the communications for which the terminals connected with the business local area network RL interfere, are controlled by the simple call module MAS in the main call server SAP. The main call server SAP controls numerous functions relative to the addressing such as the presentation of the address of the calling terminal; to particular treatments of calls required by local users such transferring a call to another terminal, automatic calls, double calls, call filtering, voice messaging, etc.; to billing; to managing the signaling in a message mode between terminals via the gateways and switches and routers in networks outside the local area network RL.

The traffic relative to call signaling messages in a packet mode transits from respective call paths from the first call strings CH1 in the server SAP to second call strings in the server SAP and/or in another call server for outgoing calls from the server SAP, and from first call strings in the server SAP and/or in another call server to second call strings CH2 in the server SAP for incoming calls to the server SAP. Such a call signaling traffic is observed in cut-off in managing modules MG1 and MG2 by the module MAS so as to insert, modify and remove signaling packets intended for gateways and for terminals being in communication. Gateways communicate data packets most often of audio type, but also of video type, during set up calls, as well as signaling messages in the packet mode. Signaling messages are relative to any predetermined characteristic event occurring during a call to managing modules, such as line or channel seizing (picking up), a tone, a prompt particularly for dialing an address such as a telephone number, a command relative to a switching or waiting period, a line or channel release (hanging up), etc. Data packets, including relative to phony for conventional accesses to digital or analog telephone external networks, are exchanged during calls set up between terminals in a transparent way between gateways through the local area network RL and the call server.

As soon as setting up a call from a local or remote called terminal T2 is requested (picking up) by a local calling terminal T1, the simple call module MAS creates an outgoing call string CH1 associated with the address of the local calling terminal T1 only for that call. In the main call server SAP with which the calling terminal is associated, the outgoing call string CH1 comprises a managing software module MG1 and a call context software module MCA1. When the call is being set up between the calling and the called terminals, the managing module MG1 monitors the operations of the calling terminal T1 by analyzing the signaling packets relative to the calling terminal and transmitted by the gateway PA1, supposing that the calling terminal T1 is connected with it, and the operations of the local or remote called terminal analyzing the signaling packets transmitted by the gateway servicing the called terminal and relative to the called terminal. The managing module MG1 derives signaling signals, such as tone or service signals, to be transmitted to the terminals as a function, more particularly, of the signaling signals it receives.

The call context module MCA1 controls on the hard disk of the main call server SAP1 the storage of a current context of the call comprising data strictly sufficient for identifying the call and, if applicable, useful for restoring a call path created during the call should the main server SAP become defective, as described later on. In a memory table of the module MCA1 attributed to the calling terminal T1, the current context of the call comprises parameters of the call path such as the address of the calling terminal T1, the address of the called terminal T2 and two references of call strings, such as port numbers, for defining a call path until the next call string of called terminal so as to reach the called terminal T2. For example, the addresses of the terminals T1 and T2 can be phone numbers. Said next call string of called terminal is included in a call server that can be the same server as the main server SAP with which the calling terminal is associated if the calling and called terminals are locally linked to this call server. According to another alternative, the call server including the next call string of called terminal can be a main call server being remote from the main server SAP and through which the call transits, for example when the business possess main call servers arranged in cascade in sites distinct from the business and the requested call transits through one or more call servers before reaching the main call server with which the remote called terminal is associated.

The call string references are more particularly the port number of the call string CH1 (MG1, MCA1) in the server SAP and the port number of the next call string of called terminal so that the server SAP exchange signaling packets relative to the call with a call context software module created by the managing module of the next call string at the starting of the setting up of said outgoing call.

The current context of the call still comprises parameters such as an indicator of the type of the connection between terminals T1 and T2 for indicating an active connection or a connection of call hold by one of the terminals for example, a count of charges counted from the starting of the call, identifiers for resources such as time interval numbers occupied by the call in a time division multiplex signal inside the server SAP, and optionally, a terminal identifier when the user of the terminal T1 has several terminals being available in the private telecommunications facility.

Each time a call is broken for any reason, the call string and the context of this call are deleted in the server SAP.

Similarly and inversely, as soon as the setting up of a call of a local called terminal T2 is requested by a local or a remote calling terminal T1, the simple call module MAS creates an incoming call string CH2 associated with the called terminal only for such a call and including a managing software module MG2 and a call context software module MCA2 in the main call server SAP with which the local called terminal T2 is associated. A call context associated with the called terminal T2 comprises parameters of the call path, such as the address of the called terminal T2, the address of the calling terminal T1 and two call string references such as the port number of the associated with the called terminal and the port number of the last call string for reaching the calling terminal T1. Such a current context of the call is recorded in a memory table of the module MCA2 attributed to the called terminal T2. The context of the call associated with the called terminal T2 also comprises an identifier for the type de connection, identifiers for internal resources inside the server associated with the terminal T2 and optionally, a terminal identifier.

Signaling packets and data packets relative to the call between terminals T1 and T2 are exchanged between the ports the numbers of which are included in the contexts associated with terminals T1 and T2, through a path connecting the servers associated with the terminals.

Referring to FIG. 2 for the description of the call restoring method according to the invention, it is assumed that a calling terminal T1 in a private telecommunications facility IT1 is associated with a call string of the calling terminal in an emergency call server SAS1 through a gateway PA1 and a local area network RL1 after the main call server SAP1 of the facility IT1 has become defective. The data of the context of the call between the calling terminal T1 and a called terminal T2, with the exception of the port number of the call string in the defective server being useless in the emergency call server, has been transferred from the main call server SAP1 to the emergency call server SAS1. The called terminal T2 is associated, through a gateway PA2 and a local area network RL2, with a called terminal call string that has been created by the simple call module MAS2 in a main call server SAP2 when the call is being set up.

According to the embodiment illustrated in FIG. 2, the call servers SAP1 and SAP2 are distinct.

Terminals T1 et T2 being in communication before the failure of the main call server SAP1 of the facility IT1, the call context module MCA2 in the call string associated with the called terminal T2 in the server SAP2 has stored a call context CT2. The context CT2 further includes the address of the called terminal T2, the address of the calling terminal T1, the port number of the call string CH2 (MG2, MCA2) in the server SAP2 and the port number of the call string CH1 (MG1, MCA1) in the defective main call server SAP1 with which the calling terminal T1 is associated for reaching the defective server.

The call restoring method comprises steps E1 to E9 as shown in FIG. 3, so that the emergency call server SAS1 substituting for the defective main call server SAP1 resumes the supervision of simple calls in the facility IT1. The path particularly for phony data between terminals T1 and T2 is broken. However, terminals T1 and T2 ignore the rupture of this path, as indicated through a link of network LR in dashed lines in FIG. 2. Terminals T1 and T2 are transparent to restoring the call if terminals remain unchanged, where they were just before the failure of the server SAP1, i.e. if no one of the users of the terminals T1 and T2 does not perform any action modifying the call such as hanging up, call holding or call transferring, for example. As will be seen later on, the contexts associated with terminals then serve to conceal the failure of the main call server so as to restoring a path between the terminals. The calls on hold and complex calls such as a double call and calls from an operator are released and are thus not considered by the emergency call server SAS1.

As a result of the failure of the server SAP1 and the replacement of the defective server SAP1 by the emergency call server SAS1, the traffic monitoring module MOT1 in the server SAS1 reads in the memory all the contexts of calls relative to calls previously set up before the failure and including the call context CT1 relative to the call of the calling terminal T1 and associated with the address of the calling terminal, in step E1. The traffic monitoring module MOT1 creates a software managing module MG1 relative to the call of the calling terminal T1 in step E2. By means of the software managing module MG1, the emergency server SAS1 locally communicates by signaling packets with the calling terminal T1 through the local area network RL1 and the gateway PA1, in step E3. Then, the managing module MG1 creates a call context software module MCA1 relative to the call of the calling terminal T1, in step E4. A call string (MG1, MCA1) associated with the call context CT1 and, hence, with the calling terminal T1 is thus created again in the emergency server SAS1 and presents in the emergency call server SAS1 a port number, as the reference of call string, which is inserted in the call context CT1 obtained from the defective server in the place of the port number of the corresponding call string deleted in the defective server SAP1. If the terminal T1 taking part in a call and associated with the defective call server SAP1 decides to break the call before the emergency call server SAS1 restores the call, the call rupture will only be considered after the creation of the call string associated with the terminal in the server SAS1.

The call path previously set up for terminals T1 and T2 between the call string in the main call server that has become defective and the call string in the main call server SAP2 is lost and the emergency server SAS1 should re-create another call path to the server SAP2 for terminals T1 and T2. In step E5 in the server SAS1, the managing module MG1 controls a simulation of line or channel seizing (picking up) by the terminal T1 in the context module MCA1, that is, a call restoring request by the terminal T1, by transmitting via the adapter AD1 a call restoring request message SIG1 to the server SAP2, the address of which is derived from the address of the terminal T2 extracted from the updated context CT1 associated with the terminal T1 and read in step E1. The message SIG1 contains the address of the calling terminal T1, the address of the called terminal T2, the port number of the call string (MG1, MCA1) recently created in the emergency server and the port number of the called terminal call string (MG2, MCA2), these terminal addresses and port number being extracted from the updated context CT1. The context module MCA1 in the emergency call server SAS1 then triggers another call to the call context module MCA2 designated by the port number of called terminal call string included in the message SIG1. Triggering said other call is intended to re-create between servers SAS1 and SAP2 a data path relative to the call between terminals T1 and T2.

In the server SAP2 in step E6, the traffic monitoring module MOT2 analyzes the call restoring request message SIG1 in order to search in memory a call context between terminals T1 and T2. For this, the module MOT2 compares the call string port number associated with the called terminal and extracted from the message SIG1 to all the port numbers, as call string references in memory of the server SAP2. If two call string port numbers are identical, the port number extracted from the message SIG1 is normally that of the call string (MG2, MCA2) associated with the called terminal T2. If the identifier of the type of connection read in the context CT2 of the call string (MG2, MCA2) previously found and associated with the called terminal T2 is consistent with restoring the call, for example, if the identifier does not indicate any call holding by the terminal T2, the context module MCA2 then compares the calling terminal address ADT1 read in the stored context CT2 associated with the second call string (MG2, MCA2) designated by the extracted port number and thus associated with the terminal T2, to the address of the calling terminal T1 extracted from the message SIG1, in step E7. If the compared addresses ADT1 are identical, this means that the call between terminals T1 and T2 is found in the server SAP2.

The context module MCA2 replaces in the stored context CT2 the port number of the call string previously associated with the calling terminal T1 in the defective main server by the port number of the recently created call string (MG1, MCA1) extracted from the received message SG1, in step E8. The new association of the ports of the call strings (MG1, MCA1) and (MG2, MCA2) in the context CT2 re-creates a data path between the server SAP2 with which the called terminal T2 is associated and the server SAS1 with which the calling terminal T1 is associated.

On the contrary, the traffic monitoring module MOT2 ignores the call restoring as requested by the message SIG1, controls in the module MAS2 the release of the call with the calling terminal T2 and a deletion in memory of modules MG2 and MCA2 in a step of call restoring rejection ERR for at least one of the following cases:

if in step E6, the module MOT2 does not know any port number in the call restoring request message SIG1 associated with one of the call strings already created in the server SAP2;

if in step E7, the identifier of the connection type read in the context CT2 of the call string (MG2, MCA2) previously found and associated with the called terminal T2 is incompatible with a call restoring, or if the compared the calling terminal addresses are different.

After step E8, the managing module MG2 confirms restoring the call between terminals T1 and T2 through the call path thus created between call strings (MG1, MCA1) and (MG2, MCA2) by transmitting via the adapter AD2 a message SIG2 to the managing module MG1 in the server SAP1, in step E9. As a result of this confirmation, the module MCA1 definitely records the ports of this path in the call context CT1 for the call of terminals T1 and T2. The managing modules MG1 and MG2 resume the dialogue between terminals T1 and T2 by joining to the path created between servers SAS1 and SAP2 the path between the server SAS1 and the terminal T1 in the facility IT1 and the path between the server SAP2 and the terminal T2 in the facility IT2. The simple call modules MAS1 and MAS2 resume monitoring the call re-set up in servers SAS1 and SAP2 including waiting the call to be released (hanging up) by one of the terminals T1 and T2.

Practically, restoring a call is in the order of 10 milliseconds, requiring a duration of 50 seconds approximately for a server treating 5,000 calls to be restored, a duration substantially equal to the mean duration of a call.

It should be noticed that, if the main call server SAP2 with which the called terminal T2 is associated, should become defective and is replaced by an emergency server SAS2 of the facility IT2, everything occurs for carrying out the call restoring steps E1 to E9 previously described as if the emergency server SAS2 was the server SAS1 in FIG. 1 and the non defective main call server SAP1 with which the called terminal T1 is associated, was the server SAP2 in FIG. 1. Consequently, the method of this invention is independent from calling and called characters of terminals T1 and T2.

As an alternative to the embodiment in FIG. 2, the defective main call server SAP1 and the main call server SAP2 has their functionalities joined into one single call server SAP1 in a private telecommunications facility IT common to terminals T1 and T2, as shown in FIG. 1. In said alternative, restoring the call between terminals T1 and T2 associated with the emergency call server SAS1 replacing the defective call server SAP1 comprises steps similar to steps E1 and E9 between a call string (MG1, MCA1) created in association with the calling terminal T1 and a call string (MG2, MCA2) that is created in association with the called terminal T2 similarly to steps E1 to E4. The data path for restoring the call between terminals T1 and T2 is then directly created between the call strings (MG1, MCA1) and (MG2, MCA2) created in the emergency server.

According to still another alternative, it is assumed that the main call server SAP1 of the facility IT1 becomes briefly defective, for example, as a result of a micro-cut resulting in call strings collapsing, followed by resuming the operation of the server SAP1, without using an emergency server. In said other alternative, the server SAP1 is considered as confused with the emergency server SAS1 in performing the call restoring steps E1 to E9.

If the first call server SAP1 and the second call server SAP2 are joined into one single call server becoming briefly defective, steps similar to steps E1 to E4 and relative to creating a second call string (MG2, MCA2) to be associated with the terminal T2 can be implemented if the second part of the single call server including second call strings also becomes defective. In such a case, the call restoring method between terminals T1 and T2 included in a common telecommunications facility comprises a step for creating the second call string (MG2, MCA2) associated with the second terminal T2 and with the second context CT2 of the call previously stored in the single call server.

This invention as herein described relates to a call method and a call server. According to an implementation, the steps of the method of the invention are determined by instructions from a computer program incorporated into the call server. The program comprises instructions of computer program which, when said program is being executed in the call server, the operation of which is then controlled by the execution of the program, perform the steps of the method according to the invention.

Consequently, this invention also applies to a computer program, including a computer program stored on or in an information medium readable by a computer or any data processing device, adapted to implement the invention. This a program can use any programming language and take the form of a source code, an object code, or any code intermediary between the source code and the object code, e.g. in any partially compiled form, or any other form suitable for implementing the method according to the invention.

The information medium can be any entity or device capable of storing the program, such as a memory, a hard disk or a USB key, or an integrated circuit into which the program is incorporated.

1. A method of restoring a previously set up call between a first terminal associated with a first call server and a second terminal associated with a second call server, said method comprising:
creating a first call string associated with said first terminal and with a first context of the call previously stored in said first call server,
transmitting a call restoring request including a second call string reference extracted from said first context from said first call server to said second call server,
searching in said second call server a second call string depending on said second call string reference included in said call restoring request, and,
if said second call string is found in association with said second terminal, confirming call restoring between said first terminal and said second terminal through a path between said first second call string and said second call string, from said second call server to said first call server.

2. A method as claimed in claim 1, wherein said call restoring request includes an address of said first terminal, an address of said second terminal and said reference of said second call string extracted from said first context, and a reference of said first call string created in said first call server.

3. A method as claimed in claim 2, wherein searching a second call string comprises in said second call server:
comparing said second call string reference extracted from said call restoring request to call string references stored in said second call server,
if two call string references are identical, comparing said address of said first terminal read in a second context associated with said second call string designated by said extracted second call string reference, to said address of said first terminal extracted from said call restoring request, and
if the compared addresses are identical, replacing a first call string reference previously associated with said first terminal by said reference of the created first call string extracted from said call restoring request.

4. A method as claimed in claim 1, wherein said first call server is an emergency server adapted to replace a call server that has become defective and with which said first terminal is also associated when said call is previously set up.

5. A method as claimed in claim 1, wherein said first call server and said second call server are merged into one single call server.

6. A method as claimed in claim 5, including creating a second call string associated with said second terminal and with a second context of said call previously stored in said single call server.

7. A system for restoring a call previously set up between a first terminal associated with a first call server and a second terminal associated with a second call server, said system comprising:
means in said first call server for creating a first call string associated with the first terminal and with a first context of the call previously stored in said first call server,
means in said first call server for transmitting a call restoring request including a second call string reference extracted from said first context to said second call server,
means in said second call server for searching a second call string depending on said second call string reference included in said call restoring request, and
if said second call string is found in association with said second terminal, means in said second call server for confirming call restoring between said first terminal and said second terminal through a path between said first call string and said second call string, from said second call server to said first call server.

8. A call server adapted to restore a call previously set up between a first terminal associated with said call server and a second terminal associated with a second call server, said call server comprising:
means for creating a first call string associated with said first terminal and with a first context of the call previously stored in said call server, and
means for transmitting a call restoring request including a second call string reference extracted from said first context to said second call server,
so that said second server searches a second call string depending on said second call string reference included in said call restoring request, and, if said second call string is found in association with said second terminal, confirms call restoring between said first and said second terminals through a path between said first call string and said second call string, to said first call server.

9. A call server for restoring a call previously set up between a first terminal associated with a first call server and a second terminal associated with said call server, said call server comprising:
means for searching a second call string depending on a second call string reference included in a call restoring request transmitted by said first call server and extracted from a first context of the call previously stored in said first call server having created a first call string associated with said first terminal, and
if said second call string is found in association with said second terminal, means for confirming a call restoring between said first and said second terminals through a path between said first call string and said second call string, to said first call server.

10. A computer readable medium or storage device storing a computer program adapted for causing a call server to restore a call previously set up between a first terminal associated with said call server and a second terminal associated with a second call server, said computer program, when said computer program is loaded and run in said call server, performing:
creating a first call string associated with said first terminal and with a context of the call previously stored in said first call server, and
transmitting a call restoring request including a second call string reference extracted from said first context to said second call server,
so that said second server searches a second call string depending on said second call string reference included in said call restoring request, and, if said second call string is found in association with said second terminal, confirms call restoring between said first terminal and said second terminal through a path between said first call string and said second string, to said first call server.

11. A computer readable medium or storage device storing a computer program for causing a call server to restore a call previously set up between a first terminal associated with a first call server and a second terminal associated with said call server, said computer program, when said computer program is loaded and run in said call server, performing:
searching a second call string depending on a second call string reference included in a call restoring request transmitted by said first call server and extracted from a first context of the call previously stored in said first call server having created a first call string associated with said first terminal, and
if said second call string is found in association with said second terminal, confirming call restoring between said first and said second terminals through a path between said first and said second call string , to said first call server.
